(19) United States
(12) Patent Application Publication
(10) Pub. No.: US 2013/0285921 A1
(43) Pub. Date: Oct. 31, 2013

(54) Systems and Methods for a Rollable Illumination Device

(71) Applicants: William P. Alberth, JR., Prairie Grove, IL (US); William S. Hede, Lake in the Hills, IL (US); Randall S. Vaas, Wyoming, MI (US)

(72) Inventors: William P. Alberth, JR., Prairie Grove, IL (US); William S. Hede, Lake in the Hills, IL (US); Randall S. Vaas, Wyoming, MI (US)

(73) Assignee: Motorola Mobility, Inc., Libertyville, IL (US)

(21) Appl. No.: 13/455,921

(22) Filed: Apr. 25, 2012

(51) Int. Cl. G06F 3/041

(52) U.S. Cl. 345/173

(57) ABSTRACT

Systems and methods are provided for managing an illumination of a flexible display (110) of an electronic device (100). According to certain aspects, the systems and methods initiate an illumination mode whereby the flexible display (110) illuminates with various display elements when the display either makes up an inner or outer surface. The rollable device (100) detects any overlap regions (204) as well as any areas associated with tactile interactions by a user of the device. Further, the rollable device (100) can obscure an illumination within the overlap regions (204) and the tactile interaction areas. In some aspects, the user can select to optically steer the illumination via touch sensors (130) located on a side opposite from the flexible display (110).

### FIELD

This application generally relates to illuminating displays of electronic devices. In particular, the application relates to platforms and techniques for illuminating areas of a flexible display based on tactile interactions by a user and configurations of the electronic device.

### BACKGROUND

Current electronic devices can offer various illumination modes, wherein the electronic device can illuminate a display to provide light in an immediate area of a user. For example, an illumination mode can be useful in situations in which the user may need light for navigation, to locate an item, to see a specific item, to indicate their presence, or for other purposes. The illumination modes can illuminate displays in solid colors of light, colored patterns of light, or other configurations.

With the advent of flexible display technology for electronic devices, there is an opportunity to manage the illumination modes of a flexible display of an electronic device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an example electronic device in accordance with some embodiments.

FIG. 2A and FIG. 2B illustrate an example electronic device in accordance with some embodiments.

FIG. 3 illustrates an example of a cross-section view of an electronic device in accordance with some embodiments.

FIG. 4 illustrates an interaction with an electronic device in accordance with some embodiments.

FIG. 5 illustrates an example of a chart associated with an interaction with an electronic device in accordance with some embodiments.

FIG. 6 illustrates an interaction with an electronic device in accordance with some embodiments.

FIG. 7 illustrates an example electronic device in accordance with some embodiments.

FIG. 8 illustrates an example electronic device in accordance with some embodiments.

FIG. 9 is a block diagram of an electronic device in accordance with some embodiments.

FIG. 10 is a flow diagram depicting content display management in accordance with some embodiments.

FIG. 11 is a flow diagram depicting content display management in accordance with some embodiments.

### DETAILED DESCRIPTION

System and methods are disclosed for illuminating a flexible display screen of an electronic device. More particularly, the electronic device can support one or more illumination modes, where the display screen of the electronic device can provide light in an immediate area around the device. According to embodiments, the flexible display can be rolled into a tube-like or oblique shape with the display screen as either an outer surface or an inner surface. The systems and methods can detect an overlap where the display screen overlaps with itself and can illuminate the display screen except for the area defined by the overlap. In cases where the display screen is the outer surface of the rollable device, the systems and methods can detect a user's tactile interaction, such as the user grasping or gripping the rollable device, identify an area defined by the interaction, and obscure the area defined by the interaction such that the area underneath the user's hand will not illuminate. In embodiments, the electronic device can detect movements of the user's grip, or changes in the overlap area, and update the display accordingly.

These illumination management techniques may reduce the amount of power used for the various illumination modes by obscuring the display screen areas defined by the overlap in the display screen as well as the user's tactile interaction with the display screen. Further, the user can comfortably grip the device without experiencing underlying heat generated by the illuminated display screen. Still further, the device can conform the illumination pattern with movements associated with the user's interaction with the touchscreen display as well as any changes to the overlap areas. Additionally, the user's interaction may select a particular illumination mode, color, or pattern. Moreover, the device can adjust or modify an optical direction of the illumination based on touch events received from a user. As used herein, a “rollable device” can be understood to be an electronic device with any combination of hardware and software including a display screen surface configured to be at least partly rolled or flexed.

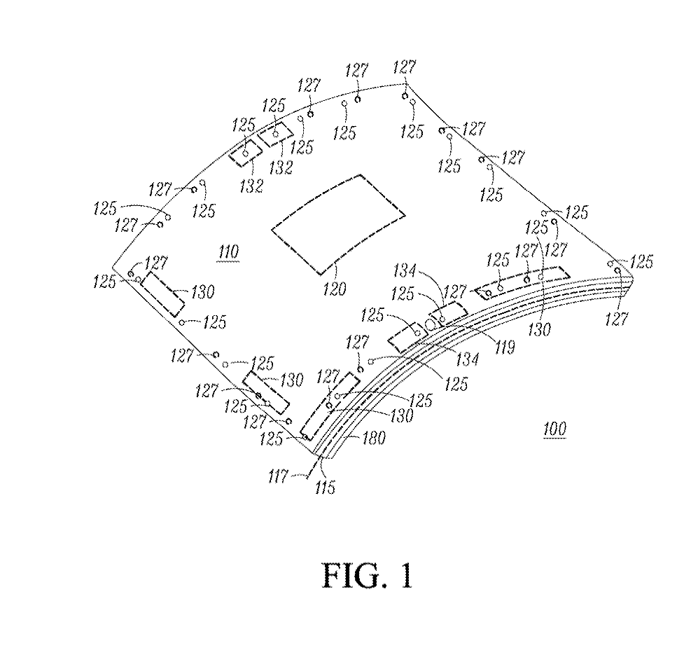

FIG. 1 depicts an example electronic device 100 consistent with some embodiments. It should be appreciated that the electronic device 100 is merely an example and can include various combinations of hardware and/or software components.

As shown in FIG. 1, the electronic device 100 can include a display screen 110. According to embodiments, the display screen 110 can be flexible, partially flexible, rollable, or partially rollable and can be configured to display graphical information. Further, the display screen 110 can be a touchscreen capable of receiving inputs from a user of the electronic device 100. More particularly, the display screen 110 can include touchscreen technologies such as resistive panels, surface acoustic wave (SAW) technology, capacitive sensing (including surface capacitance, projected capacitance, mutual capacitance, and self-capacitance), infrared, optical imaging, dispersive signal technology, acoustic pulse recognition, and/or others. Further, the display screen 110 can use display technology such as electrophoretic displays, electronic paper, polyLED displays, AMOLED displays, OLED displays, liquid crystal displays, electrowetting displays, rotating ball displays, segmented displays, direct drive displays, passive-matrix displays, active-matrix displays, and/or others.

As shown in FIG. 1, the electronic device 100 can include a substrate 115 that can be configured to support the display screen 110. In particular, the substrate 115 can be a thin flexible layer made with metal, plastic, or other materials or combinations of materials. The display screen 110 and the substrate 115 can individually include one or more parts or components for supporting the display functions such as, for example, backlights, reflectors, and/or other components. The substrate 115 may also include an artificial muscle 117 that will later be explained in more detail. The electronic device 100 can further include a flexible battery 180 that can be capable of rolling or flexing in conjunction with the display screen 110 and the substrate 115. The electronic device 100 can be rolled such that either the display screen 110 or the flexible battery 180 can form at least a part of the outer surface of the electronic device 100. The electronic device 100 can also include a processing module 120 that can be an integrated circuit containing a processor and other components configured to process user input and sensor data, and manage content display functionalities as discussed herein. As shown in FIG. 1, the processing module 120 can be located underneath or adjacent to the flexible battery 180, or can be located in other areas.

As shown in FIG. 1, the electronic device 100 is further configured with a set of overlap sensors 125, 127, touch sensors 130, and an optional additional sensor 119. A first set of overlap sensors 125 can be placed on or embedded within the display screen 110 so that, when the electronic device 100 is rolled, the front overlap sensors 125 can detect, sense, and/or help the processing module 120 refine a positioning of an overlap region(s) of the display screen 110. In embodiments, the set of overlap sensors 125 can be CMOS image sensors that can be embedded among display pixels of the display screen 110. A second set of overlap sensors 127 can be placed opposite the display screen 110, oriented to receive light from behind the display screen 110, to help detect, sense, and/or refine locations of the overlap region(s). For example, the set of rear overlap sensors 127 can be placed on or embedded within the flexible battery 180, and can be CMOS image sensors or other sensors.

In this embodiment, the flattened display screen 110 is rectangular in shape; however, any flattened shape is possible including circular, oval, triangular, polygonal, and irregular (e.g., like a flower, an alphanumeric character, or a leaf). In various embodiments, the sets of overlap sensors 125, 127 can be positioned closer or farther from the edges of the respective display screen 110 or the flexible battery 180. Further, it should be appreciated that there can be any number of overlap sensors 125, 127 positioned in any arrangement or orientation on the respective display screen 110 or the flexible battery 180. For example, there can be overlap sensors positioned throughout the center area of the display screen 110. In cases where the electronic device 100 is rolled into a more conical or otherwise irregular shape, the overlap sensors positioned near or around the center area, in addition to some of the overlap sensors near the edges, can be blocked or otherwise not detect any light.

During an initialization step, the electronic device 100 can determine the extent of overlap of the display screen 110 with itself by briefly illuminating the entire display 110 using a particular light wavelength and sensing which of the overlap sensors 125, 127 receive or do not receive that light. Based on the sensor information, the electronic device 100 can calculate an area where the display screen 110 overlaps with itself. More particularly, the electronic device can detect or approximate the overlap area based which of the overlap sensors 125, 127 do not receive the initial light wavelength or detect any ambient light. A non-overlap area can be defined by the overlap sensors 125, 127 that receive a combination of one or more of the initial light wavelength and ambient light. The overlap sensors 125, 127 that do or do not receive the initial light wavelength and ambient light will vary based on the shape or configuration of the device (e.g., conical, cylindrical, etc.), whether the display screen 110 is rolled inside or outside, and/or other factors. For example, if the electronic device 100 is rolled a conical shape, then some overlap sensors 125, 127 on one end of a particular edge of the electronic device 100 will not detect any light while other overlap sensors 125, 127 on the opposite end of the same edge will detect light. In embodiments, the display screen 110 and/or the flexible battery 180 can include a greater concentration of overlap sensors 125, 127 near the ends of the edges to more accurately detect the overlap regions associated with conical or otherwise irregular configurations.

The touch sensors 130 can sense or detect user contact to control some display functionalities of the electronic device 100. In some embodiments, the touch sensors 130 are dynamically-determined areas of the display screen 110 when the display is configured as a touchscreen. In other embodiments, the touch sensors 130 are buttons or keys. As shown in FIG. 1, the touch sensors 130 can be located underneath or adjacent to the flexible battery 180, or can be located in other areas.

The additional sensor 119 can be any type of imaging sensor or detection component, such as a camera or proximity sensor, that can aid in locating objects and detecting changes in positions of objects within a proximity of the electronic device 100. For example, the additional sensor 119 can help the processing module 120 identify a user's position in relation to a section of the rolled-up electronic device 100 optionally so that the processing module 120 can “follow” the user's movement around the outside of the electronic device 100. For further example, the additional sensor 119 may assist in detecting whether sections of the display screen 110 are obscured, for example if the electronic device 100 is lying on a table.

According to embodiments, the electronic device 100 can support a variety of functionalities and applications. For example, the electronic device 100 can support communication functionalities such as telephone calls, text messaging, video calls, Internet browsing, emailing, and/or the like. In the embodiment shown in FIG. 1, piezo elements 132, 134 are positioned and configured to act as microphones and speakers for supporting telephony and other voice functions. For example, a first set of piezo elements 132 can act as microphones and a second set of piezo elements 134 can perform as speakers. Further, for example, the electronic device 100 can support applications such as games, utilities (e.g., calculators, camera applications, etc.), configuration applications, and/or the like. The electronic device 100 can also support voice-activation technology that allows users to initiate and operate functions and applications of the electronic device 100. In embodiments, the electronic device 100 can be configured to connect to various wired or wireless personal, local, or wide area networks to facilitate communication with network components and/or other devices.

According to embodiments, the processing module 120 of the electronic device 100 can be configured to manage illumination modes of the electronic device 100. In particular, the processing module 120 can interface with the sensors and other components of the electronic device 100 to modify the illumination of the display screen 110. For example, the processing module 120 can obscure an illumination in any overlap areas of the display screen 110 or areas associated with a tactile interaction by a user. For example, the illumination can be obscured by directing no illumination of pixels in overlapped areas of the display screen 110. Further, the processing module 120 can detect touch events via the touch sensors 130 and adjust directions of illumination according to the touch events.

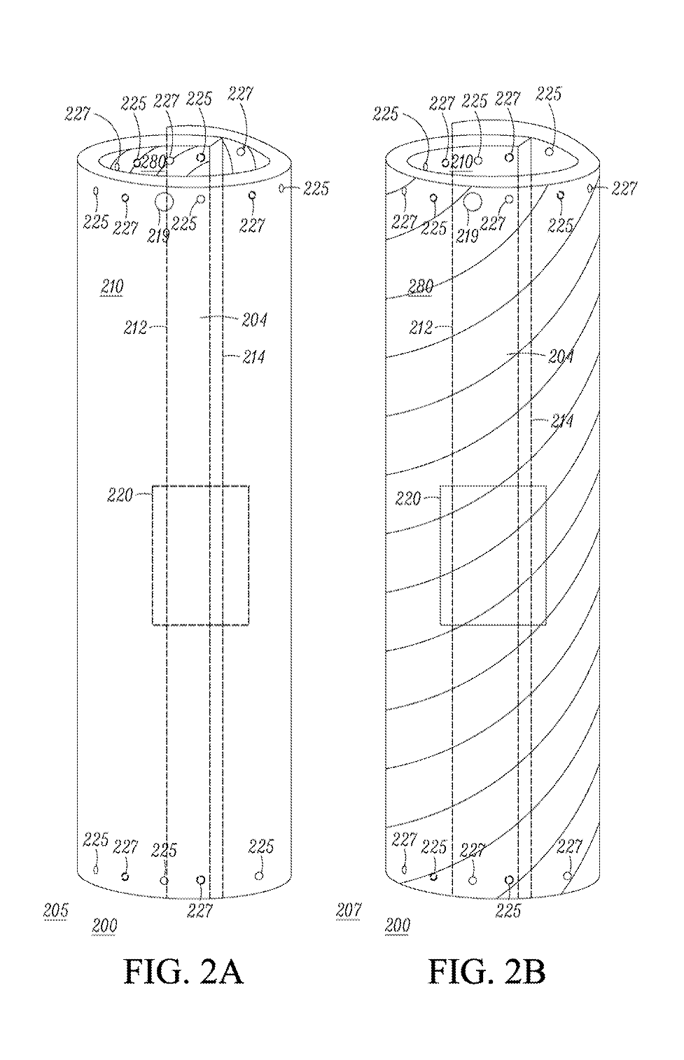

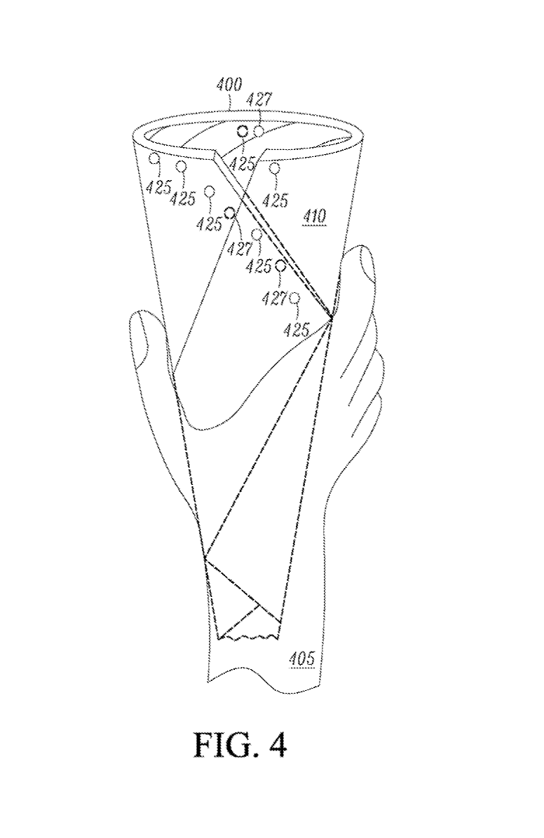

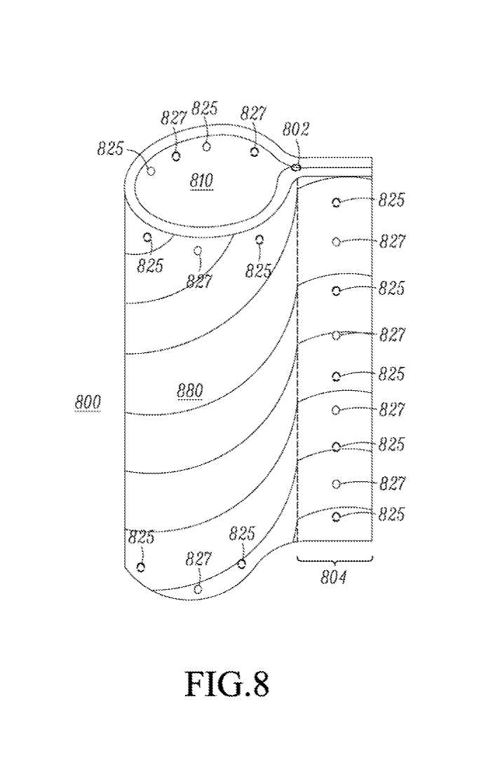

FIG. 2A and FIG. 2B depict views of an example electronic device 200 shown in two configurations 205, 207 in accordance with embodiments. Each of the configurations 205, 207 shows a rectangular flexible display (such as the display 110) rolled into a tube-like shape. It should be appreciated that other rollable configurations are envisioned, including cone-like shapes (see FIG. 4), tear drop-like shapes (see FIG. 8), or other oblique shapes. Further, in cases in which the electronic device is rectangular in shape, the embodiments envision the configurations 205, 207 as being rolled either “long-wise” or “short-wise.”

The configuration 205 as depicted in FIG. 2A has a display screen 210 on the outside surface and a flexible battery 280 is on the inside surface. Conversely, the electronic device configuration 207 as depicted in FIG. 2B has the display screen 210 on the inside surface and the flexible battery 280 on the outside surface. Similarly, a processing module 220 can be located on the inside surface of the electronic device 200 and/or the outside surface of the electronic device 200. The electronic device 200 can also be configured with an optional sensor 219 to determine a viewing position of a user, track movements of the user, detect nearby objects or surfaces, and/or perform other optical detection functionalities.

Front and rear overlap sensors 225, 227 can be configured to detect, sense, or otherwise locate an overlap region 204 when the electronic device is in either configuration 205, 207. More particularly, the sets of overlap sensors 225, 227 can sense or detect events indicating that at least part of the display screen 210 is obscured as a result of an overlap with itself, the flexible battery 280, and/or other components. The front overlap sensors 225 can be positioned on the display screen 210 and the rear overlap sensors 227 can be positioned on the flexible battery 280, and in any type of configuration, as discussed with respect to FIG. 1. As shown in FIGS. 2A and 2B, the overlap regions 204 are defined by borders 212 and 214. For example, when the entire display screen 210 is briefly illuminated using a light of a particular wavelength, the sensors receiving that wavelength of light and the sensors not receiving that wavelength of light can be analyzed to determine the configuration 205, 207 and the extent of the overlap region 204. When respective illumination modes of the configurations 205, 207 are initiated, the flexible display 210 can be illuminated except for the respective overlap regions 204. It should be appreciated that the systems and methods contemplate various orientations, amounts of, and location placements for the sensor 219 and the sets of overlap sensors 225, 227.

In the configuration 205 in which the display screen 210 is on the outside surface, one or more front overlap sensors 225 on one edge of the display screen 210 can be blocked, and thus detect the overlap region 204, while one or more front overlap sensors 225 on the opposite edge of the display screen 210 can detect ambient light. More particularly, during an initialization step of the electronic device, the front overlap sensors 225 that are not blocked can detect ambient light including some initialization light of the particular wavelength, and the front overlap sensors 225 that are blocked can detect little or no light. Further, one or more rear overlap sensors 227 on one edge of the flexible battery 280 can detect the initialization light strongly because they are positioned directly against the display screen 210 of an opposite edge, and one or more rear overlap sensors 227 on the opposite edge of the flexible battery 280 can be unblocked yet detect little initialization light, because those rear sensors 227 will be on the inner (battery 280) surface of the configuration 205. Thus, the measurements of the overlap sensors 225, 227 can be used to estimate a size and shape of the overlap region 204 as well as the configuration 205.

In the configuration 207 in which the display screen 210 is on the inside surface, one or more front overlap sensors 225 on one edge of the display screen 210 can be blocked, and thus detect the overlap region 204, while one or more front overlap sensors 225 on the opposite edge of the display screen 210 can detect light ambient light including initialization light. More particularly, during an initialization step of the electronic device, the front overlap sensors 225 that are not blocked can detect strongly any initialization light of the particular wavelength, and the front overlap sensors 225 that are blocked can detect little or no light. The detection of initialization light by unblocked front overlap sensors 225 can be very strong, because the front sensors 225 are on the inside of the tube configuration 207. Further, one or more rear overlap sensors 227 on one edge of the flexible battery 280 can detect the initialization light strongly because they are positioned directly against the display screen 210 of an opposite edge, and one or more rear overlap sensors 227 on the opposite edge of the flexible battery 280 can be unblocked yet detect little initialization light, because those rear sensors 227 will be on the outer (battery 280) surface of the configuration 205. Thus, the measurements of the overlap sensors 225, 227 can be used to estimate a size and shape of the overlap region 204 as well as the configuration 207.

The electronic device in either configuration 205, 207 can further include a substrate that includes an artificial muscle component that can change shape or size when stimulated by an electric charge. For example, the artificial muscle can be an electroactive polymer made with piezoelectric materials that can deform when subject to a voltage application, and which also generate a voltage when deformed. In operation, the artificial muscle can activate or engage to hold the electronic device in a position. For example, the user can roll the electronic device into a tube-like shape, and the artificial muscle can activate to maintain the shape. In some cases, the bending of the artificial muscle by an external force (e.g., the user) can activate an electrical signal, and a polarity of the signal can indicate whether the electronic device is in configuration 205 or configuration 207, or in other words whether the device is rolled with the flexible display as an inside surface or an outside surface.

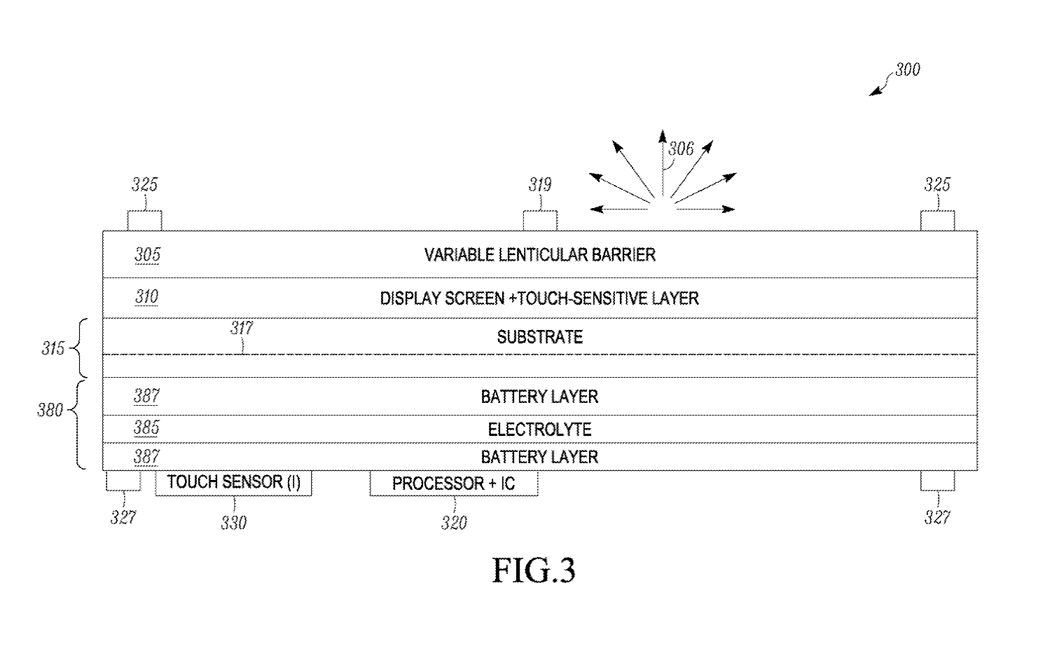

FIG. 3 depicts a cross-section view of an electronic device 300. It should be appreciated that the cross-section view is merely an example and the electronic device 300 can include various combinations of components and placements thereof.

As shown in FIG. 3, the electronic device 300 can include a display screen 310 with a touch-sensitive layer integrated therein. More particularly, the touch-sensitive layer can sense touch events with, for example, a user's hand. The electronic device 300 can include a variable lenticular barrier 305 that can control the direction of the display of content. For example, the variable lenticular barrier 305 can display content in any or all directions as indicated by arrows 306 as shown in FIG. 3. According to embodiments, a user of the electronic device 300 can control the content display direction via one or more touch sensors 330. As shown in FIG. 3, the electronic device 300 can also have front overlap sensors 325, rear overlap sensors 327, and an optional additional sensor 319, as discussed herein. In embodiments, the front overlap sensors 325 and the additional sensor 319 can be disposed on the variable lenticular barrier 305, a battery layer 387, or in/on other locations of the electronic device 300, such as within the active matrix of the display screen 310.

The electronic device 300 can further include a substrate 315 that can be capable of supporting the display screen 310. The substrate 315 can include an artificial muscle 317 component that can change shape or size when stimulated by an electric charge. For example, the artificial muscle 317 can be an electroactive polymer made with piezoelectric materials that can deform when subject to a voltage application, and which also generate a voltage when deformed. In operation, the artificial muscle 317 can activate or engage to hold the electronic device 300 in a position. For example, the user can roll the electronic device 300 into a tube-like shape, and the artificial muscle 317 can activate to maintain the shape. In some cases, the bending of the artificial muscle 317 by an external force (e.g., the user) can activate an electrical signal, and a polarity of the signal can indicate whether the electronic device 300 is rolled with the display screen 310 as an inside surface or an outside surface.

The electronic device 300 can be powered by a battery 380 including one or more battery layers 387 and an electrolyte layer 385. In embodiments, the battery layers 387 can be lithium-ion batteries or other battery types or variants, and can be made using various types of conductive material. Further, in embodiments, the electrolyte layer 385 can include LiPON or other materials or combinations of materials. It should be appreciated that although the battery is depicted as having two battery layers 387 and one electrolyte layer 385, embodiments contemplate various amounts and combinations of layers, as well as materials and compositions thereof. In embodiments, the battery layers 387 and the electrolyte later 385 can be laminated or otherwise affixed to the substrate 315 or other components of the electronic device 300.

According to some embodiments, the electronic device 300 can have a processing module 320 and the one or more touch sensors 330 disposed on the battery layer 387. In operation, the processing module 320 can include an integrated circuit, a processor, and other components, and can be configured to interface with the battery layers 387, the artificial muscle 317, the display screen 310, the variable lenticular barrier 305, the overlap sensors 325, 327, the additional sensor 319, and the one or more touch sensors 330 to process and facilitate the operations and functionalities of the electronic device 300 as discussed herein.

Referring to FIG. 4, depicted is an example rollable device 400 in accordance with embodiments. It should be appreciated that the rollable device 400 is merely an example and other components, sizes of components, and scales of components are envisioned. The rollable device 400 includes a display screen 410 that makes up an outer surface of the rollable device 400 in this configuration, and can display content and receive input from a user at any location(s) of the outer surface. Note that the overlap region in this configuration is triangular rather than rectangular in shape. The rollable device 400 can include a set of front overlap sensors 425 positioned on the display screen 410 and a set of back overlap sensors 427 positioned on the flexible battery that can detect the overlap area, as discussed herein.

As shown in FIG. 4, a user's hand 405 is depicted grasping, gripping, or otherwise making contact with the display screen 410. In some cases, the display screen 410 can be inactive or otherwise not displaying any content when contacted by the user's hand 405. If an illumination mode is initiated subsequent to the contact, the display screen 410 can be configured to obscure any overlap areas as well as any areas or regions associated with the user contact. In other cases, the display screen 410 can be in an illumination mode initiated prior to the user's hand 405 contacting the display screen 410. In yet other situations, the illumination mode can be initiated prior to rolling the display screen 410 and the overlap region, as well as the hand 405 contact region, is subsequently determined. When contacted, the display screen 410 can be configured to obscure any overlap areas as well as any areas or regions associated with user contact.

According to embodiments, the rollable device 400 can determine a position of the user's hand 405 and components thereof (e.g., thumb, index finger, etc.) after the user's hand 405 makes contact with the display screen 410. For example, the display screen 410 can recognize touch events at one or more of a series of nodes of the display screen 410, generate signals corresponding to the touch events, and send the signals to a processor of the rollable device 400. The processor can analyze the signals to determine a mapping of the touch events and the corresponding points of contact by the user's hand 405.

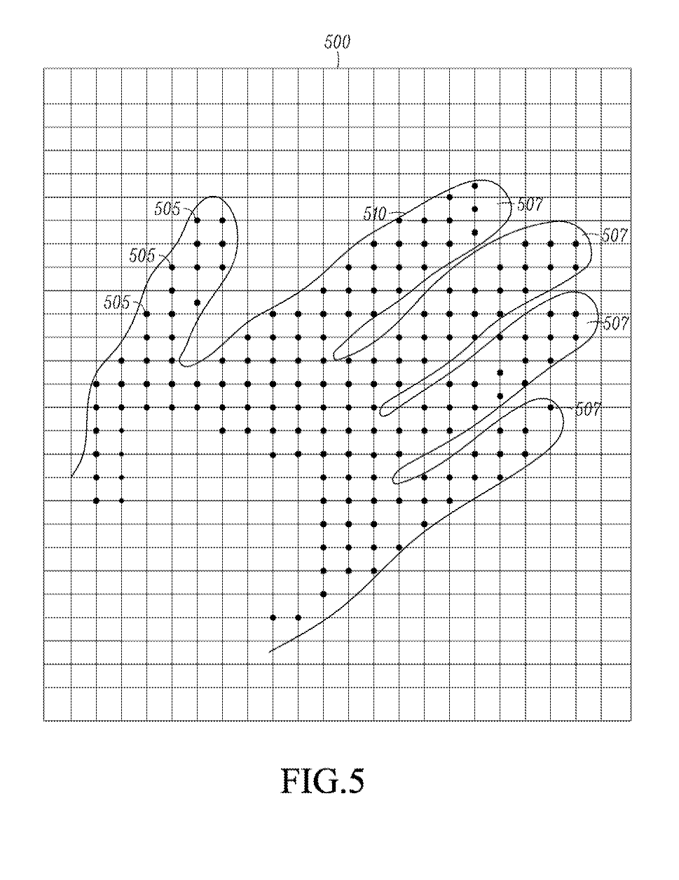

Referring to FIG. 5, an illustration of a display screen interface 500 and nodes thereof are depicted. More particularly, the display screen interface 500 depicts a two-dimensional view of an outer surface touchscreen of a rollable electronic device (such as the display screen 410 as discussed with respect to FIG. 4). As shown, the display screen interface 500 represents a touchscreen including a series of nodes, depicted as grid line intersections, that can sense a surface contact from, for example, a user's hand. More particularly, the touchscreen can detect a surface contact with one or more contacted nodes 505. Further, the touchscreen can generate a signal(s) in response to the nodes 505 being contacted and transmit the signal(s) to a processor of the electronic device. Upon receipt, the processor can generate an image of the display screen interface 500 at a particular point in time, and in response to the nodes 505 sensing contact. In embodiments, the signals corresponding to the contacted nodes 505 can have indications of high or low points based on changes in capacitance due to the surface contact at each of the contacted nodes 505. The processor can compare the generated image to previous images to identify changes in surface contact as well as determine which action(s) to perform. For example, the processor can detect that a user's hand re-grips the display screen interface 500 and determine that a graphic can be re-displayed at a location or region based on the new nodes that sense contact. Thus, a formerly obscured region can become unobscured.

According to embodiments, the processor can analyze the signals corresponding to the contacted nodes 505 to determine an outline 510 of a user's hand. More particularly, the processor can approximate the sizes and locations of individual fingers, locate fingertips 507, and can generate the outline 510 according to the approximations. In some cases, the outline 510 can encompass most or all of the contacted nodes 505 at a point in time. In other cases, some user grips will only include the area contacted by the fingertips 507. In embodiments, the processor can determine or approximate a size of the user's hand based on the shape and size of the outline 510 or the size of the fingertips 507 and distance between the detected fingertips 507. Further, the processor can examine the outline 510 to determine which hand (left or right) is contacting the touchscreen, as well as the specific fingers (e.g., thumb, index finger, etc.) and the locations of the specific fingers.

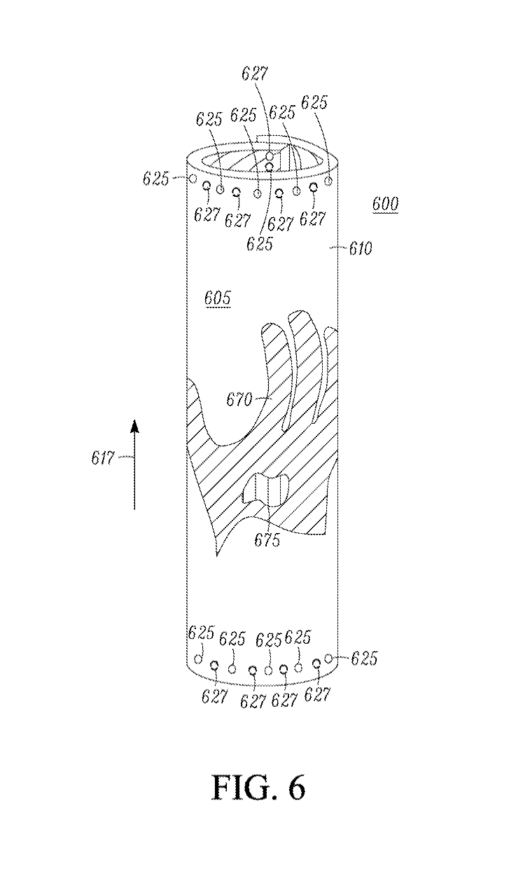

Referring to FIG. 6, depicted is an example rollable device 600 that supports an illumination mode. More particularly, FIG. 6 illustrates various contact and non-contact areas defined by a user's tactile interaction with the rollable device 600.

As shown in FIG. 6, the rollable device 600 includes a flexible display 610 with a non-contacted area 605 and a contacted area 670. In embodiments, the contacted area 670 can be detected via touch events at one or more nodes of the rollable device 600, as discussed herein. During operation of an illumination mode, the rollable device 600 can illuminate the pixels or display components corresponding to the non-contacted area 605 with lights or other display elements in various colors, arrangements, patterns, or the like. Further, the rollable device 600 can obscure or otherwise not illuminate the pixels or display components corresponding to the contacted area 670. For example, in cases in which the illumination mode is initiated after the user contacts the rollable device 600 (and after the contacted area 670 is identified), the rollable device 600 can illuminate just the non-contacted area 605. For further example, in cases in which the illumination mode is initiated without any user contact, the rollable device 600 can illuminate the entire touchscreen display, but if user contact is subsequently detected, the rollable device 600 can obscure or de-illuminate the contacted area 670. In embodiments, the rollable device 600 can also detect an overlap area where the flexible display overlaps within itself and obscure the overlap area. The rollable device 600 can include a set of front overlap sensors 625 positioned on the flexible display and a set of back overlap sensors 627 positioned on the flexible battery that can detect the overlap area, as discussed herein.

As shown in FIG. 6, the flexible display can also include an enclosed area 675 that can correspond to an area that is not contacted by the user but that is at least partially surrounded by the contacted area 670. More particularly, the enclosed area 675 can correspond to an area that is not directly contacted by the user's tactile interaction, but that is presumably “covered” by the user's hand or other actuating area. For example, the enclosed area 675 can correspond to the palm of a user's hand that does not make contact with the touchscreen display but still covers a viewable portion of the touchscreen display. According to embodiments, the rollable device 600 can identify the enclosed area 675 by identifying pixels, nodes, or other display elements that do not have associated touch events but are surrounded by pixels, nodes, or other display elements that do have associated touch events. In some embodiments, the enclosed area 675 can also include areas or regions that are in proximity to contacted areas but are not necessarily fully enclosed by the contacted areas. Even though the enclosed area 675 is not directly contacted by the hand, the enclosed area 675 is presumed to be obscured from the user's view, and any information output from the display would not be viewable.

In operation, in response to identifying the area 675, the rollable device 600 can be configured to obscure or otherwise not illuminate the area 675. For example, in cases in which the illumination mode is initiated after the user contacts the rollable device 600 (and after the contacted area 670 and the enclosed area 675 are identified), the rollable device 600 can illuminate just the non-contacted area 605, even though the enclosed area 675 is not contacted. For further example, in cases in which the illumination mode is initiated without any user contact, the rollable device 600 can illuminate the entire flexible display, but after the user contact is detected, the rollable device 600 can obscure or de-illuminate the contacted area 670 and the enclosed area 675, even though the enclosed area 675 is not contacted.

According to embodiments, the rollable device 600 can adjust the illumination according to movements or changes in the user's interaction. More particularly, if the user re-grips or adjusts his/her grip on the rollable device 600, the rollable device 600 can identify or track any updated non-contacted areas 605, contacted areas 670, and/or enclosed areas 675. Further, the rollable device 600 can adjust the illumination based on the updated areas. For example, if the user adjusts his/her grip upward in a direction 617 as indicated in FIG. 6, the rollable device 600 can obscure a previously-illuminated area (or previously non-contacted area 605) and/or illuminate a previously-obscured area (or previously contacted area 670 and/or enclosed area 675).

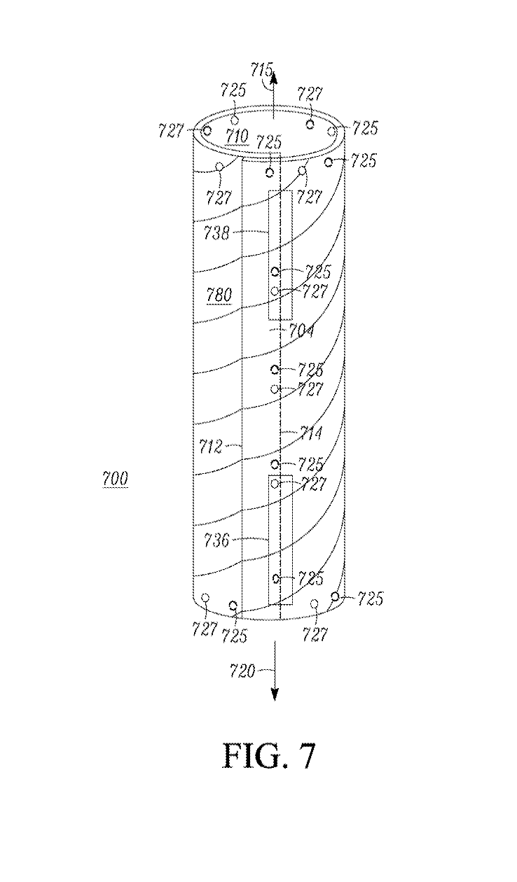

Referring to FIG. 7, depicted is an example rollable device 700 that supports illumination functionalities. FIG. 7 depicts the rollable device 700 as rolled into a tube-like shape with a flexible display 710 forming an inner surface of the rollable device 700, however other tube-like and oblique shapes are envisioned.

As shown in FIG. 7, the rollable device 700, when rolled, overlaps at an overlap area 704 defined by boundaries 712, 714 of the rollable device 700. More particularly, the rollable device 700 can include a set of front overlap sensors 725 positioned on the flexible display 710 and a set of back overlap sensors 727 positioned on the flexible battery that can detect the overlap area 704, as discussed herein. During operation of an illumination mode of the rollable device 700, the rollable device 700 can illuminate the flexible display 710 except for the overlap area 704. In embodiments, the rollable device 700 can further include a set of touch sensors 736, 738 that can detect touch events by a user. For example, the touch events can be touches, gestures such as swipes, and/or other types of touch events. As shown in FIG. 7, the touch sensors 736, 738 are respectively located near the top and bottom edges of the rollable device 700, as well as near the edge 712. The touch sensors 736, 738 can be implemented as part of a capacitive sensing layer, for example a capacitive sensing layer of a display screen, or as separate physical buttons or keys. It should be appreciated that the touch sensors 736, 738 can be located or disposed at different regions or sides (e.g., flexible display 710 side or flexible battery 780 side) of the rollable device 700, can be in different amounts, and can have different shapes or configurations. Further, different touch sensors can be active or accessible in different configurations of the rollable device 700.

The flexible display 710 can be configured with a lenticular barrier (shown in FIG. 3) that can control directions of the illumination. In operation, different sections of the flexible display 710 can illuminate and, when the light passes through the lenticular barrier, the light can be optically steered in various directions. For example, the light can be steered in an up direction as indicated by 715 and/or a down direction as indicated by 720. According to embodiments, a user of the rollable device 700 can control the illumination direction of the flexible display 710 via touch events with the touch sensors 736, 738. For example, if the rollable device 700 detects a touch event at the touch sensor 736, the rollable device 700 can optically steer the illumination of the flexible display in the down direction 720. Similarly, if the rollable device 700 detects a touch event at the touch sensor 738, the rollable device 700 can optically steer the illumination of the flexible display in the up direction 715. For further example, if the rollable device 700 detects a touch event at either of the touch sensors 736, 738 and the flexible display 710 is already illuminated in the respective direction 715, 720, the rollable device 700 can obscure or otherwise not illuminate the flexible display in the respective direction 715, 720. It should be appreciated that other interactions and illumination functionalities via the touch sensors 736, 738 and the lenticular barrier are envisioned.

FIG. 8 depicts an example rollable device 800 that supports illumination functionalities. The rollable device 800 has a flexible display 810 that can be a component of the inside surface and a flexible battery 880 that can be a component of the outside surface of the rollable device 800. However, it should be appreciated that the flexible display can be the outside surface and the flexible battery can be the inside surface.

As referenced by 802 in FIG. 8, the rollable device 800 is in a “pinch” configuration whereby opposite ends on the same side of the rollable device 800 are back-to-back, adjacent, contiguous, or otherwise in close proximity. The “pinch” configuration can result in an overlap area 804 whereby the flexible display 810 is concealed in areas where it doubles over itself. A set of front overlap sensors 825 can detect or sense the overlap area 804, as well as any movements or changes in the overlap area 804, as discussed herein. As shown in FIG. 8, the front overlap sensors 825 can be positioned on the flexible display 810. Contrary to the overlap area of the configurations as shown in FIGS. 4 and 7, the overlap area 804 of the “pinch” configuration is detected by overlap sensors on one side of the rollable device 800, or more particularly the front overlap sensors 825 as shown in FIG. 8. Any sensors on the flexible battery 880, such as a set of back overlap sensors 827, will not detect the overlap area 804. It should be appreciated that various amounts and placements of the set of overlap sensors 825, 827 are envisioned. In some cases, an artificial muscle can retain the rollable device 800 in the “pinch” configuration.

According to embodiments, the rollable device 800 can illuminate the flexible display 810 except for the overlap area 804. Further, the rollable device 800 can modify the illumination according to any movements or changes sensed or detected by the set of overlap sensors 825, 827 or other components. In cases in which the flexible display 810 is the outside surface and the flexible battery 880 is the inside surface, the overlap area can be defined by an area of the flexible battery 880 that doubles over itself as detected by the rear overlap sensors 827. In this case, the rollable device 800 can illuminate the flexible display 810 except for an area obscured by a hand carrying the rollable device 800. The rollable device 800 includes the set of back overlap sensors 827 positioned on the flexible battery 880 that can detect the overlap area of the flexible battery 880 when the flexible battery 880 is the inside surface. With the “pinch” configuration having the flexible display 810 on the outside, the overlap area of the flexible battery 880 can be detected by just the set of back overlap sensors 827, and the set of front overlap sensors 825 will not detect the overlap area.

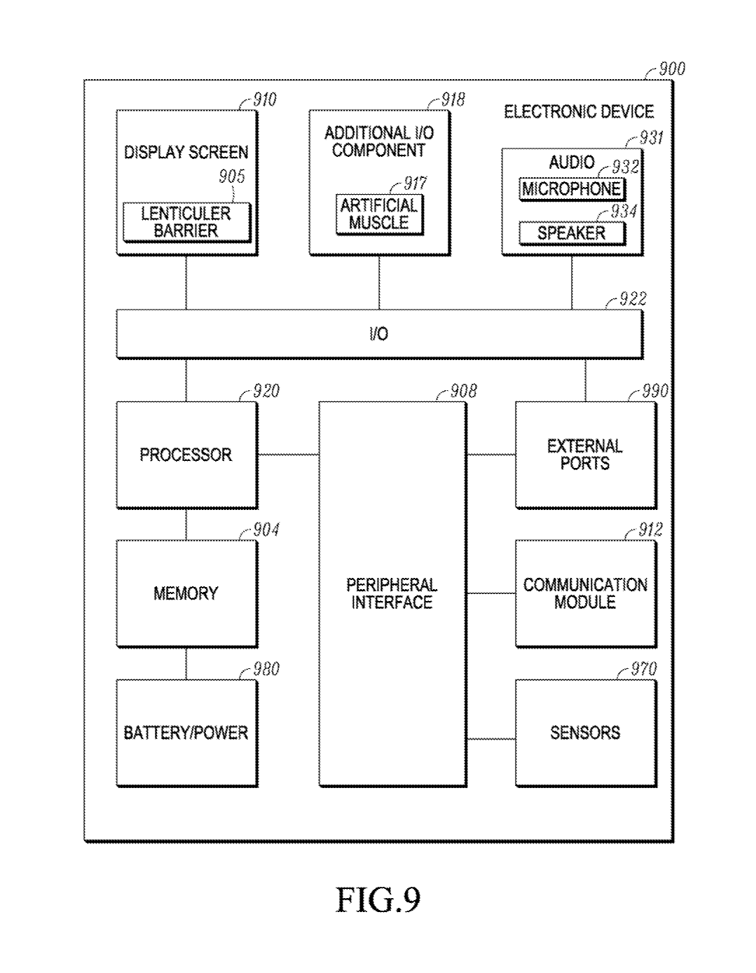

FIG. 9 illustrates an example electronic device 900 in which the embodiments may be implemented. The electronic device 900 can include a processor 920, memory 904 (e.g., hard drives, flash memory, MicroSD cards, and others), a power module 980 (e.g., flexible batteries, wired or wireless charging circuits, etc.), a peripheral interface 908, and one or more external ports 990 (e.g., Universal Serial Bus (USB), HDMI, Firewire, and/or others). The electronic device 900 can further include a communication module 912 configured to interface with the one or more external ports 990. For example, the communication module 912 can include one or more transceivers functioning in accordance with IEEE standards, 3GPP standards, or other standards, and configured to receive and transmit data via the one or more external ports 990. More particularly, the communication module 912 can include one or more WWAN transceivers configured to communicate with a wide area network including one or more cell sites or base stations to communicatively connect the electronic device 900 to additional devices or components. Further, the communication module 912 can include one or more WLAN and/or WPAN transceivers configured to connect the electronic device 900 to local area networks and/or personal area networks, such as a Bluetooth® network.

The electronic device 900 can further include one or more sensors 970 such as, for example, accelerometers, gyroscopic sensors (e.g., three angular-axis sensors), proximity sensors (e.g., light detecting sensors, or infrared receivers or transceivers), overlap sensors such as as front overlap sensors 125 and rear overlap sensors 127, tilt sensors, cameras such as additional sensor 119, touch sensors 130, and/or other sensors; and an audio module 931 including hardware components such as a speaker 934 for outputting audio and a microphone 932 for receiving audio. In embodiments, the speaker 934 and the microphone 932 can be piezoelectric components. The electronic device 900 further includes an input/output (I/O) controller 922, a display screen 910, and additional I/O components 918 (e.g., an artificial muscle 917, capacitors, keys, buttons, lights, LEDs, cursor control devices, haptic devices, and others). The display screen 910 and the additional I/O components 918 may be considered to form portions of a user interface (e.g., portions of the electronic device 900 associated with presenting information to the user and/or receiving inputs from the user).

In embodiments, the display screen 910 is a touchscreen display using singular or combinations of display technologies such as electrophoretic displays, electronic paper, polyLED displays, OLED displays, AMOLED displays, liquid crystal displays, electrowetting displays, rotating ball displays, segmented displays, direct drive displays, passive-matrix displays, active-matrix displays, and/or others. Further, the display screen 910 can include a thin, transparent touch sensor component superimposed upon a display section that is viewable by a user. For example, such displays include capacitive displays, resistive displays, surface acoustic wave (SAW) displays, optical imaging displays, and the like. The display screen can also include a lenticular barrier 905 configured to control an illumination direction.

The display screen 910 can be configured to interact with various manipulators, such as a human finger or hand. Each type of manipulator, when brought into contact with the display screen 910, can cause the display screen 910 to produce a signal that can be received and interpreted as a touch event by the processor 920. The display screen 910 can also detect any overlap regions associated with the electronic device 900. The processor 920 is configured to determine the location of the contact on the surface of the display screen 910, as well as other selected attributes of the touch event (e.g., movement of the manipulator(s) across the surface of the screen, directions and velocities of such movement, touch pressure, touch duration, and others).

The display screen 910 or one of the additional I/O components 918 can also provide haptic feedback to the user (e.g., a clicking response or keypress feel) in response to a touch event. The display screen 910 can have any suitable rectilinear or curvilinear shape, and may be oriented, rolled, or otherwise manipulated in any desired fashion. The illustrated embodiments, without loss of generality, depict rectangular regions rolled into a tube-like shape. However, embodiments comprehend any range of shapes, sizes, and orientations for the display screen 910 such as, for example, tear drop- or cone-like shapes, semi-rolled shapes, and/or the like. In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 920 (e.g., working in connection with an operating system) to implement a user interface method as described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

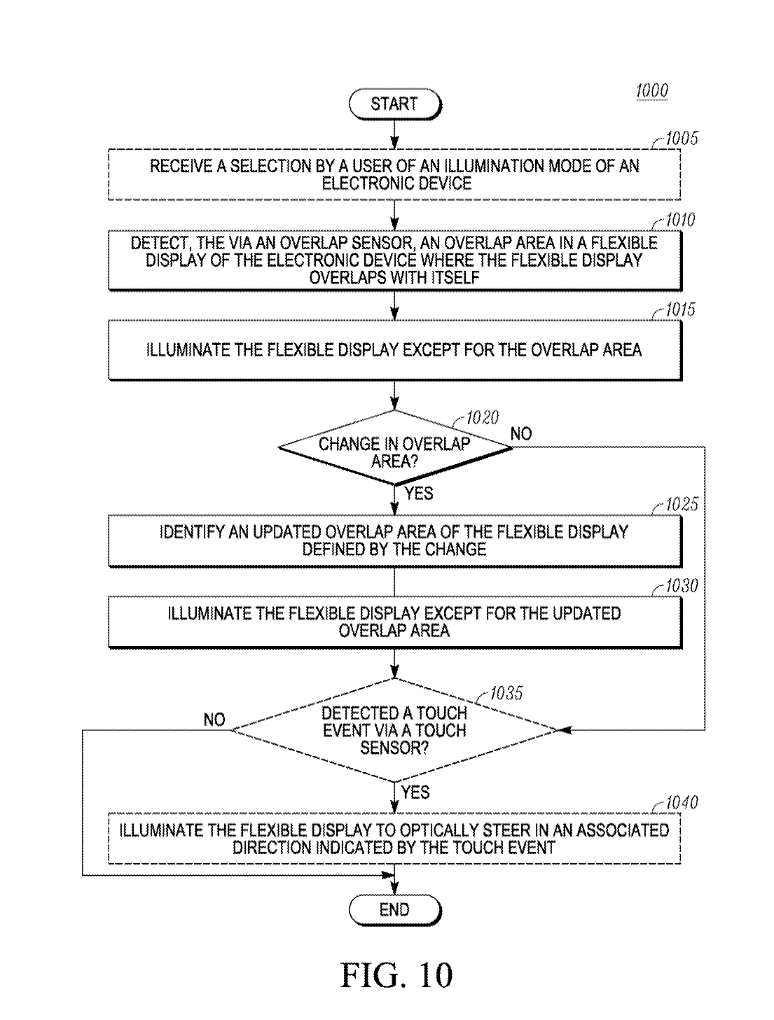

FIG. 10 is a flowchart of a method 1000 for an electronic device (such as the electronic device 100 as shown in FIG. 1) to manage an illumination mode on a flexible display of the electronic device. More particularly, the method 1000 relates to the electronic device managing the illumination mode when the flexible display is rolled as an inside surface of the electronic device.

The method 1000 begins with the electronic device optionally receiving 1005 a selection by a user of an illumination mode. For example, the illumination mode can be a “flashlight mode” whereby the flexible display illuminates on the inside surface to provide light in an immediate area of the electronic device. The electronic device detects 1010, via an overlap sensor, an overlap area in the flexible display where the flexible display overlaps within itself. In some situations, the electronic device can illuminate an entire area of the flexible display in a particular wavelength, and the electronic device can detect the overlap area based on which overlap sensors detect or do not detect the light of the particular wavelength. The detection configurations of the overlap sensors can be dependent upon the location, orientation, and/or amount of the overlap sensors. The overlap area can be defined as the area where the flexible display overlaps with a flexible battery or other components of the electronic device. It some cases, the overlap area can be defined by a “pinch” configuration whereby opposite edges of the same side of the electronic device are contiguous. The electronic device illuminates 1015 the flexible display except for the overlap area.

The electronic device determines 1020 if there is a change in the overlap area. For example, the change can be detected as a result of the electronic device being handled by a user. If there is a change in the overlap area (“YES”), the electronic device identifies 1025 an updated overlap area of the flexible display defined by the change and illuminates 1030 the flexible display except for the updated overlap area. In contrast, if there is not a change in the overlap area (“NO”), the electronic device determines 1035 if a touch event has been detected via a touch sensor. In particular, the touch sensor can be located or disposed on an outside surface of the electronic device, opposite from the flexible display. If a touch event is detected (“YES”), the electronic device illuminates 1040 the flexible display to optically steer in an associated direction indicated by the touch event. For example, the associated direction can be an angled direction out of one of the ends of the rolled-up electronic device. In embodiments, the optical steering can be facilitated by a lenticular barrier. If a touch event is not detected (“NO”), then the functionality can end, start over, or return to any previous step.

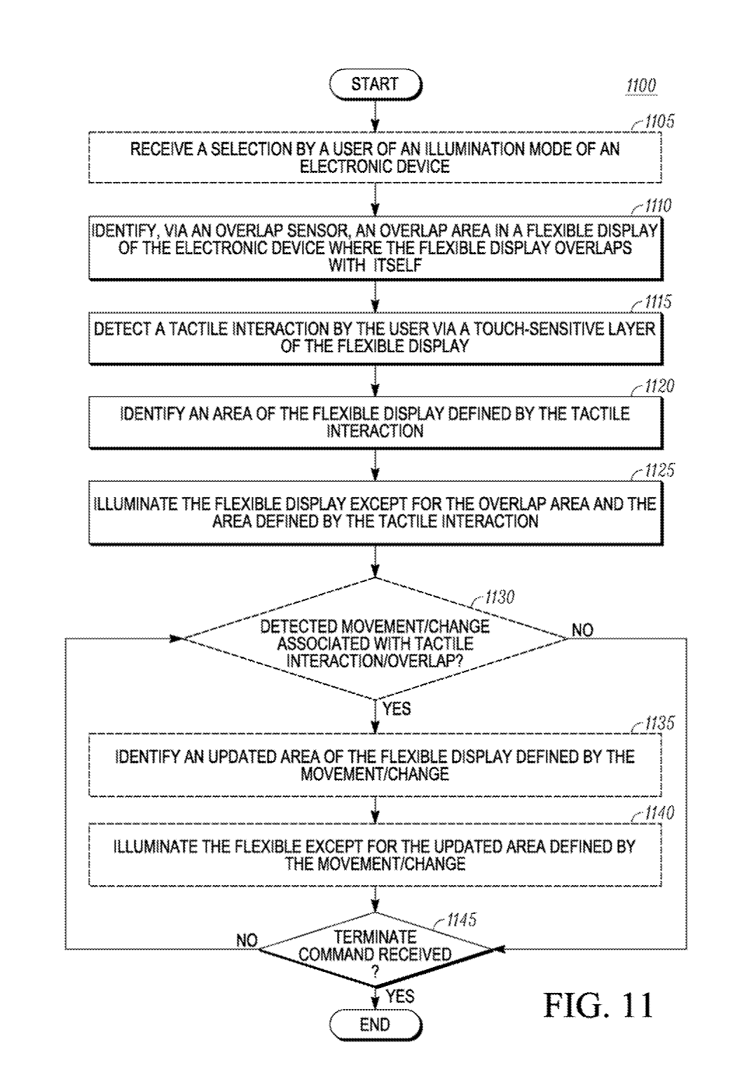

FIG. 11 is a flowchart of a method 1100 for an electronic device (such as the electronic device 100 as shown in FIG. 1) to manage an illumination mode on a flexible display of the electronic device. More particularly, the method 1100 relates to the electronic device managing the illumination mode when the flexible display is rolled as an outside surface of the electronic device.

The method 1100 begins with the electronic device optionally receiving 1105 a selection by a user of an illumination mode. For example, the illumination mode can be a “glow stick” whereby the flexible display illuminates on the outside surface to provide light in an immediate area of the electronic device. The electronic device detects 1110, via an overlap sensor, an overlap area in the flexible display where the flexible display overlaps within itself. In some situations, the electronic device can illuminate an entire area of the flexible display in a particular wavelength, and the electronic device can detect the overlap area based on which overlap sensors detect or do not detect the light of the particular wavelength. The detection configurations of the overlap sensors can be dependent upon the location, orientation, and/or amount of the overlap sensors. The overlap area can be defined as the area where the flexible display overlaps with a flexible battery or other components of the electronic device. It some cases, the overlap area can defined by a “pinch” configuration whereby opposite edges of the same side of the electronic device are contiguous. The electronic device also detects 1115 a tactile interaction by the user via a touch-sensitive layer of the flexible display. For example, the user can grasp the electronic device (such as illustrated in FIG. 4) with his/her left or right hand such that multiple fingers of the user's hand are in contact with the touchscreen. The electronic device identifies 1120 an area of the flexible display defined by the tactile interaction and illuminates 1125 the flexible display except for the overlap area and the area defined by the tactile interaction.

The electronic device determines 1130 if there is a movement or change associated with the tactile interaction or the overlap. If there is a movement or change (“YES”), the electronic device identifies 1135 an updated area of the flexible display defined by the movement or change. For example, the movement can be associated with the user re-gripping the device and the change can be associated with an adjustment of the overlap area. The electronic device illuminates 1140 the flexible display except for the updated area defined by the movement or change. If a movement or change is not detected (“NO”), then the electronic device determines 1145 if a terminate command is received. If a terminate command is received (“YES”), then the functionality can end, start over, or return to any previous step. In contrast, if a terminate command is not received (“NO”), then processing can return to 1130, end, or return to any other step.

Thus, it should be clear from the preceding disclosure that a method and apparatus manages a flexible display of an electronic device. The methods and systems allow for less energy output by the electronic device by obscuring areas of the flexible display. Further, the methods and systems allow for dynamically changing illumination functionalities based on user input.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. An electronic device comprising:
a flexible display;
a processor configured to interface with the flexible display and perform operations comprising:
detecting an overlap area of the flexible display where the flexible display overlaps within itself, and
illuminating the flexible display except for the overlap area.

2. The electronic device of claim 1, wherein the electronic device further comprises:
an overlap sensor, and
wherein the processor is further configured to interface with the overlap sensor and perform the detecting comprising:
identifying, via the overlap sensor, the overlap area of the flexible display when the flexible display is rolled.

3. The electronic device of claim 1, wherein the processor is further configured to perform operations comprising:
detecting a change in the overlap area,
identifying an updated overlap area of the flexible display defined by the change, and
illuminating the flexible display except for the updated overlap area.

4. The electronic device of claim 1, wherein the flexible display comprises a touch sensitive layer and wherein the processor is further configured to perform operations comprising:
detecting a tactile interaction by a user via the touch sensitive layer of the flexible display,
identifying an area of the flexible display defined by the tactile interaction, and
illuminating the flexible display except for the overlap area and the area defined by the tactile interaction.

5. The electronic device of claim 4, wherein the processor is further configured to perform operations comprising:
detecting a movement associated with the tactile interaction by the user via the touch-sensitive layer,
identifying an updated area of the flexible display defined by the movement, and
illuminating the flexible display except for the updated area defined by the movement.

6. The electronic device of claim 4, wherein the illuminating the flexible display except for the overlap area comprises:
illuminating an entire area of the flexible display,
obscuring an illumination of the overlap area,
detecting the tactile interaction by the user via the touch sensitive layer subsequent to the illuminating the entire area, and
obscuring an illumination of the area defined by the tactile interaction in response to the detecting the tactile interaction.

7. The electronic device of claim 4, wherein the identifying the area of the flexible display defined by the tactile interaction comprises:
identifying a contact area defined by one or more contact points of the tactile interaction,
identifying an enclosed area surrounded by the one or more contact points, and
combining the contact area with the enclosed area to define the area defined by the tactile interaction.

8. The electronic device of claim 1, wherein the overlap area is defined by a region whereby opposite edges on a same side of the electronic device are contiguous.

9. The electronic device of claim 1, further comprising:
a touch sensor disposed on a side of the electronic device opposite from the flexible display, and
wherein the processor is further configured to perform operations comprising:
detecting a touch event by a user via the touch sensor, the touch event indicating an associated direction, and
illuminating the flexible display to optically steer in the associated direction.

10. The electronic device of claim 9, further comprising:
a lenticular barrier disposed on the flexible display, and
wherein the illuminating the flexible display to optically steer in the associated direction comprises:
determining a portion of the lenticular barrier corresponding to the associated direction, and
illuminating the flexible display via the portion of the lenticular barrier.

11. A method of illuminating a flexible display of an electronic device, the method comprising:
detecting an overlap area of the flexible display where the flexible display overlaps within itself; and
illuminating the flexible display except for the overlap area.

12. The method of claim 11, further comprising:
detecting a change in the overlap area;
identifying an updated overlap area of the flexible display defined by the change; and
illuminating the flexible display except for the updated overlap area.

13. The method of claim 11, wherein the flexible display comprises a touch sensitive layer and wherein the method further comprises:
detecting a tactile interaction by a user via the touch sensitive layer of the flexible display;
identifying an area of the flexible display defined by the tactile interaction; and
illuminating the flexible display except for the overlap area and the area defined by the tactile interaction.

14. The method of claim 13, further comprising:
detecting a movement associated with the tactile interaction by the user via the touch-sensitive layer;
identifying an updated area of the flexible display defined by the movement; and
illuminating the flexible display except for the updated area defined by the movement.

15. The method of claim 13, wherein the illuminating the flexible display except for the overlap area comprises:
illuminating an entire area of the flexible display;
obscuring an illumination of the overlap area;
detecting the tactile interaction by the user via the touch sensitive layer subsequent to the illuminating the entire area; and
obscuring an illumination of the area defined by the tactile interaction in response to the detecting the tactile interaction.

16. The method of claim 13, further comprising:
detecting a withdrawal of the tactile interaction by the user; and
illuminating the area defined by the tactile interaction in response to the detecting the withdrawal.

17. The method of claim 13, wherein the identifying the area of the flexible display defined by the tactile interaction comprises:
identifying a contact area defined by one or more contact points of the tactile interaction;
identifying an enclosed area surrounded by the one or more contact points; and
combining the contact area with the enclosed area to define the area defined by the tactile interaction.

18. The method of claim 11, further comprising:
detecting a touch event by a user via a touch sensor disposed on a side of the electronic device opposite from the flexible display, the touch event indicating an associated direction; and
illuminating the flexible display to optically steer in the associated direction.

19. A method of illuminating a flexible display of an electronic device, the method comprising:
illuminating the flexible display, wherein the flexible display is rolled as an inside surface of the electronic device;
detecting a touch event by a user via a touch sensor disposed on an outside surface of the electronic device, the touch event indicating an associated direction; and
adjusting the illuminating the flexible display to optically steer in the associated direction.

20. The method of claim 19, wherein a lenticular barrier is disposed on the flexible display, and wherein the adjusting the illuminating the flexible display comprises:
determining a portion of the lenticular barrier corresponding to the associated direction; and
illuminating the flexible display via the portion of the lenticular barrier.
